(19) United States
(12) Patent Application Publication
(10) Pub. No.: US 2017/0315319 A1
(43) Pub. Date: Nov. 2, 2017

(54) PUSHABLE FIBER OPTIC CABLE FOR SMALL DUCTS

(71) Applicant: Corning Optical Communications LLC, Hickory, NC (US)

(72) Inventors: Michael John Gimblet, Conover, NC (US); James Arthur Register, III, Hickory, NC (US)

(21) Appl. No.: 15/654,970

(22) Filed: Jul. 20, 2017

Related U.S. Application Data
(63) Continuation of application No. 15/157,654, filed on May 18, 2016, now abandoned.
(60) Provisional application No. 62/164,147, filed on May 20, 2015.

(51) Int. Cl. G02B 6/44; G02B 6/54

(52) U.S. Cl. CPC G02B 6/4429; G02B 6/54

(57) ABSTRACT

A fiber optic cable includes a jacket having an outside diameter and an inside diameter, the inside diameter defining a central bore having a centerline, a pair of tightly buffered optical fibers extending longitudinally through the central bore, and a pair of strength members extending longitudinally through the central bore, wherein the optical fibers and the strength members are un-stranded and arranged such that each one of the optical fibers is diametrically opposed from the other optical fiber and abutting the pair of strength members.

### CROSS-REFERENCE TO RELATED APPLICATIONS

This application is a continuation of U.S. patent application Ser. No. 15/157,654, filed on May 18, 2016, which claims priority to U.S. Provisional Application No. 62/164,147, filed on May 20, 2015, each of which is incorporated herein by reference.

### BACKGROUND

### Field of the Disclosure

The disclosure relates generally to fiber optic cables and more particularly to a small pushable fiber optic cable that permits up to two tight-buffered fiber optic cables to be installed in a small diameter microduct.

### Technical Field

Pushing a fiber optic cable into a duct is typically limited by a point at which the cable begins to buckle. Conventional cable designs incorporate stranded components to enhance the flexibility of a cable while also reducing bending strain on the optical fiber. However, the reduction in cable stiffness induced by the stranding also makes it such that the cable becomes difficult to push through a duct for any significant distance. Special blowing equipment must instead be used during a typical deployment of the stranded cable into small ducts.

What is needed is a non-stranded cable with enhanced stiffness that allows pushing the cable through small ducts over long distances, a cable that can eliminate the need for special blowing equipment while maintaining minimum strain versus bending attributes in order to limit fiber fatigue failures.

### SUMMARY

A fiber optic cable is disclosed that includes a jacket having an outside diameter and an inside diameter, the inside diameter defining a central bore having a centerline, a pair of tightly buffered optical fibers extending longitudinally through the central bore; and a pair of strength members extending longitudinally through the central bore, wherein the optical fibers and the strength members are un-stranded and arranged such that each one of the optical fibers is diametrically opposed from the other optical fiber and abutting the pair of strength members.

In yet another aspect of the present disclosure, a fiber optic cable has a jacket having an outside diameter and an inside diameter, the inside diameter defining a central bore having a centerline, a pair of tightly buffered optical fibers extending longitudinally through the central bore, and a strength member extending longitudinally through the central bore, wherein the optical fibers and the strength members are un-stranded and arranged such that each one of the optical fibers is abutting one another and the strength member, and wherein the jacket is tightly extruded about the optical fibers and strength member to minimize the distance of the optical fibers from the centerline of the central bore.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIGS. 1A and 1B show a pushable cable in accordance with aspects of the present disclosure, FIG. 1A having a tight extruded jacket and FIG. 1B having a loose extruded jacket.

FIGS. 2A and 2B show a pushable cable in accordance with other aspects of the present disclosure, FIG. 2A having a tight extruded jacket and FIG. 2B having a loose extruded jacket.

FIG. 3 is a table illustrating the fiber bending strain vs. bend radius for different fiber offsets scenarios, in accordance with aspects of the present disclosure.

FIG. 4 illustrates fiber reliability in bending for 125 micron silica glass, in accordance with aspects of the present disclosure.

FIG. 5 illustrates another embodiment of a pushable cable in accordance with aspects of the present disclosure;

FIG. 6 is an illustration of Euler's Column Buckling Equation; and

FIG. 7 illustrates a method for determining the Equivalent Column Lengths for Various End Conditions in accordance with aspects of the present disclosure.

### DETAILED DESCRIPTION

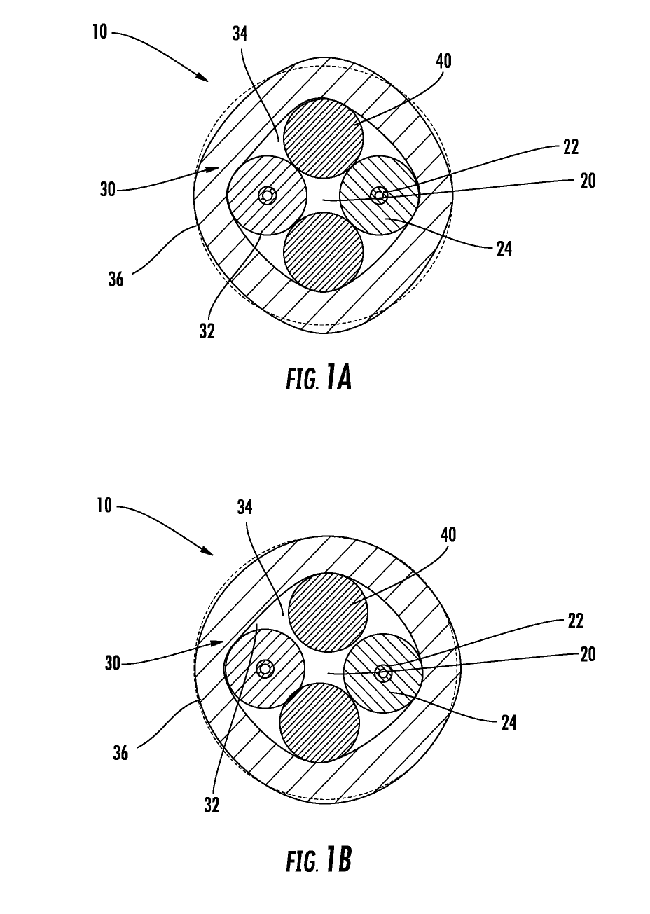

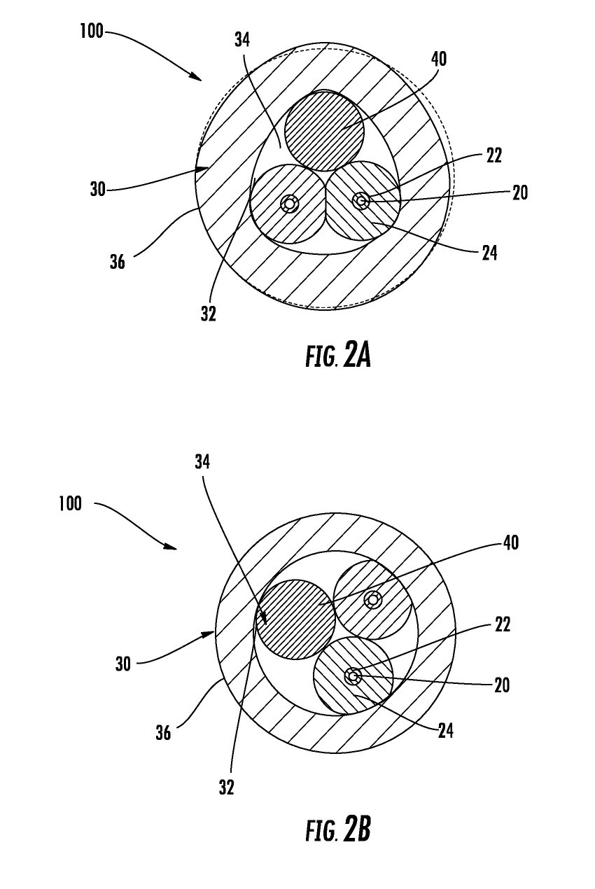

FIGS. 1A and 1B illustrate a fiber optic cable 10 in accordance with aspects of the present disclosure. The cable 10 may include two tight-buffered optical fibers 20. Each optical fiber 20 guides light through a principle known as “total internal reflection,” where light waves are contained within a core by a cladding that has a different index of refraction than the core. The core and cladding are not labeled in FIGS. 1A and 1B, but together define the optical fiber 20 and may comprise glass (e.g., germanium-doped silica). A tight buffered fiber may comprise an optical fiber with a typical outside diameter of 250 μm. One or more coating layers surround the optical fiber 20 to protect the optical fiber 20 from the environment and mechanical loads. In the embodiment shown, a primary coating 22 surrounds the optical fiber 20, and a secondary coating 24 surrounds the primary coating 22 so that the tight buffered fiber may have an outside diameter of up to 900 μm or more. The primary coating 22 may be an acrylic polymer or the like and simply be referred to as “the coating”. The secondary coating 24 may comprise polyvinyl chloride (PVC), polyurethane, polyolefin, polyamide (PA), highly filled polyethylene (PE) based compounds, for example FRNC (flame-retardant non-corrosive) compounds, and simply be referred to as a “tight buffer” or “tight buffer coating” (the latter term will be used herein).

As shown in FIGS. 1A and 1B, cable 10 includes a cable body, shown as a cable jacket 30, having an inner surface 32 defining a central bore 34 and an outer surface 36. The jacket 30 can be formed primarily from polymer materials, and can be generally referred to as “polymeric.” In this specification, the terms “polymer” and “polymeric” indicate materials comprised primarily of extrudable polymer materials such as, for example, copolymers, but allows for the presence of non-polymer materials such as additives and fillers. Two elongate strength members 40, such as glass-reinforced plastic (GRP) rods or metallic wires, are situated in the central bore 34 in substantially diametrically opposed positions. The two tightly buffered optical fibers 20 extend longitudinally through the central bore 34, also in substantially diametrically opposed positions. In FIG. 1A, the jacket 30 is tightly extruded about the fibers 20 and the strength members 40 to minimize the distance that the outside surface of the optical fibers 20 may be from the centerline of the cable. As shown in FIG. 1B, the jacket 30 may be more loosely extruded about the fibers 20 and strength members 40 such that a gap 50 between the fibers 20 is slightly larger. The jacket 30 abuts and exerts a constraining force against the optical fibers 20 and the strength members 40.

FIGS. 2A and 2B illustrate a cable 100 in accordance with aspects of the present disclosure. The cable 100 may include two tight-buffered optical fibers 20 and only one elongate strength member 40 situated in the central bore 34 of the jacket 30. The two tightly buffered optical fibers 20 extend longitudinally through the central bore 34 and are abutting. In FIG. 2A, the jacket 30 is tightly extruded about the fibers 20 and the strength member 40, whereas in FIG. 1B, the jacket 30 may be more loosely extruded about the fibers 20. The jacket 30 abuts and exerts a constraining force against the optical fibers 20 and the strength member 40.

The cables 10 and 100 shown in FIGS. 1-2 are un-stranded. The fibers 20 and strength member 40 are constrained within the jacket to lie substantially parallel to one another along the longitudinal length of the cable. There is no intentional twisting or stranding imparted to the optical fibers 20 and the strength member(s) 40. The configuration as such provides an increased benefit in enhanced stiffness for pushing the cables 10 and 100 through a miniduct, for example. However, the increased stiffness comes with other considerations, which are factored into Euler's equation illustrated in FIG. 7, and a maximum bending strain on the optical fibers 20, which is governed by the maximum distance of glass from the centerline of the cable (or neutral axis of bending). The maximum bending strain becomes limiting due to potential fatigue failures in the glass.

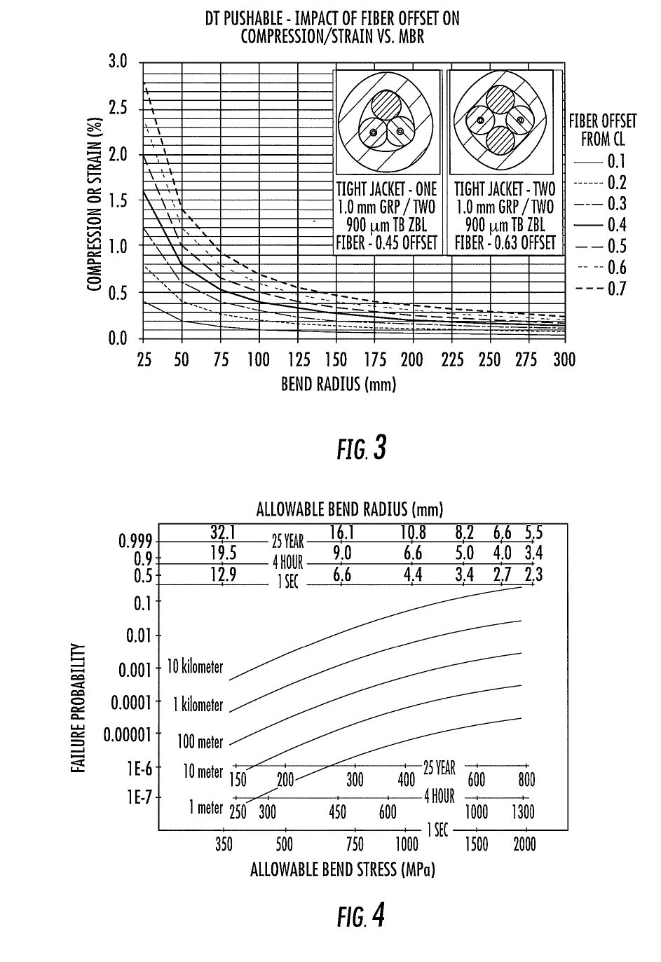

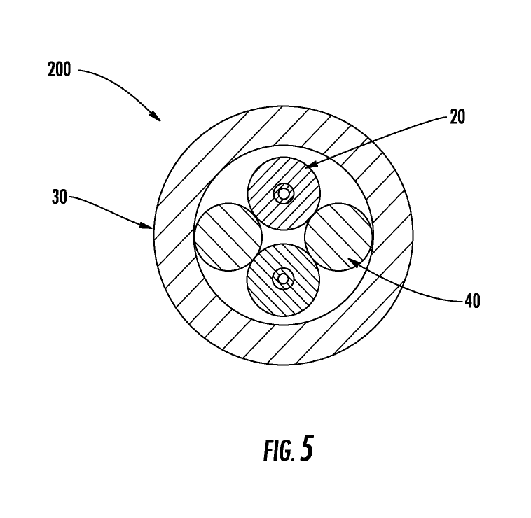

FIG. 3 is a table illustrating calculations for maximum fiber edge strain in bending for different bend diameters of the optical fibers 20. For example, assuming a 100 mm bend radius of a cable being pushed, the table illustrates that cable 10 of FIG. 1A exhibits a maximum bending strain of 0.63%. Cable 10 in this example may include two strength members 40 having a 1 mm diameter that are arranged in the jacket 30 with two tight buffered 900 μm optical fibers 20. Cable 100 of FIG. 2A on the other hand, which in this example has only one strength member 40 arranged in the jacket 30 with two tight buffered 900 μm optical fibers 20, has a slightly reduced maximum bending strain of 0.45% due to the shorter distance of the fibers 20 from the centerline. As illustrated in FIG. 4, the projected failure rate of a fiber 20 may be determined, which is between 1 and 10 parts per million for a 1 meter section of fiber under a 100 mm bend radius for 100 kpsi silica glass. 200 kpsi fiber may also be utilized to address bending strain.

FIG. 5 illustrates that smaller tight buffered fibers 20 and/or smaller diameter strength members 40 may be used to provide a reduced outside diameter (OD) in a cable 200. Reducing the cable OD to less than 3 mm, for example, such as to 2.7 mm as shown in FIG. 5, may also reduce the fiber bending strain by reducing the distance the fibers 20 are from the centerline. The example in FIG. 5 illustrates a cable 200 having a 750 micron tight buffered solution. The 750 micron tight buffered fibers 220 in this example provide for a reduced cable OD. For comparison, the cables 10 and 100 from FIGS. 1 and 2, when used with a duct having a 4.0 mm inside diameter, provide for an approximately 56% fill ratio by area. The smaller 2.7 mm cable shown in FIG. 5, on the other hand, gives approximately the same fill ratio but for a duct having an 3.5 inside diameter. The cables 10, 100, and 200, in accordance with aspects of the present disclosure, thus allow smaller ducts to be used from those used with convention stranded cables today, allowing, for example, 3.5 mm inside diameter ducts or 4.0 mm inside diameter ducts. Although described above with 900 micron or 750 micron tight buffered optical fibers, other size optical fibers, such as 500 micron optical fibers, may be used and provide the same benefits described herein.

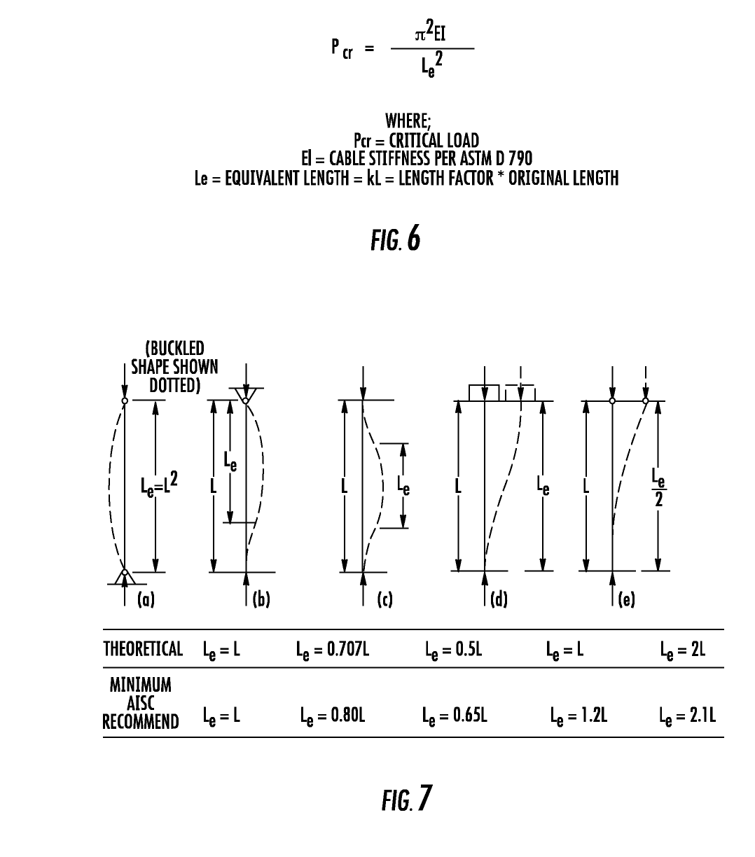

Cables 10, 100, and 200 of FIGS. 1, 2 and 5, respectively, must also take into consideration the compression experienced by the inside fiber in addition to the fiber strain on the outside fiber of the preferential bend. As shown in FIG. 6, a critical load may be calculated that corresponds to where the cable will buckle when being pushed. The critical load determination factors in the cable stiffness as determined per ASTM D 790 testing, and an Equivalent Length variable Lₑ. FIG. 7 illustrates methods for determining Lₑ based on the buckling pattern of the cable based on a given length between end conditions, such as a human hand pushing and a duct opening. The end conditions for pushing a cable into a miniduct as contemplated by this disclosure, may generally resemble the condition labeled “(c)” in FIG. 7 such that Le=0.65 L. The cables in accordance with aspects of the present disclosure are designed in view of these parameters to have an optimal stiffness for pushing yet provide sufficient flexibility to bend around corners in the duct path. The cable designs hold the optical fibers in place to allow for the fibers to be compressed or, allow for movement of the fibers to elevate the compression without causing attenuation problems. This is important as the application will have multiple bends in the duct path.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A fiber optic cable, comprising:
a jacket having an outside diameter and an inside diameter, the inside diameter defining a central bore having a centerline;
a pair of tightly buffered optical fibers extending longitudinally through the central bore, each fiber having an outside surface; and
a pair of strength members extending longitudinally through the central bore, wherein the optical fibers and the strength members are un-stranded and arranged such that each one of the optical fibers is diametrically opposed from the other optical fiber and abutting the pair of strength members, and wherein the jacket is tightly extruded about the pair of tightly buffered optical fibers and the pair of strength members such that the jacket abuts and exerts a constraining force against the optical fibers and the strength members and a distance from the outside surface of each fiber to the centerline is minimized.

2. The fiber optic cable of claim 1, wherein the strength members are glass-reinforced plastic (GRP) rods or metallic wires.

3. The fiber optic cable of claim 1, wherein each tightly buffered optical fiber is a 900 μm optical fiber.

4. The fiber optic cable of claim 1, wherein each tightly buffered optical fiber is a 750 μm optical fiber and the outside diameter of the fiber optic cable is 2.7 millimeters or less.

5. The fiber optic cable of claim 1, wherein the cable has a maximum bending strain of 0.63%.

6. A fiber optic cable assembly, comprising:
a fiber optic cable comprising:
a jacket having an outside diameter and an inside diameter, the inside diameter defining a central bore having a centerline;
a pair of tightly buffered optical fibers extending longitudinally through the central bore; and
a strength member extending longitudinally through the central bore, wherein the optical fibers and the strength member are un-stranded and arranged such that each one of the optical fibers is abutting one another and the strength member, and wherein the jacket is tightly extruded about the optical fibers and strength member such that the jacket abuts and exerts a constraining force against the optical fibers and the strength member to minimize the distance of the optical fibers from the centerline of the central bore; and
a duct having a 4 mm inside diameter, wherein the fiber optic cable provides approximately a 56% fill ratio by area when inserted inside of the duct.

7. The fiber optic cable assembly of claim 6, wherein the strength member is a glass-reinforced plastic (GRP) rod or metallic wire.

8. The fiber optic cable assembly of claim 6, wherein each tightly buffered optical fiber is a 900 μm optical fiber.

9. The fiber optic cable assembly of claim 6, wherein each tightly buffered optical fiber is a 750 μm optical fiber.

10. The fiber optic cable assembly of claim 6, wherein the cable has a maximum bending strain of 0.45%.
